(19) United States
(12) Patent Application Publication
(10) Pub. No.: US 2005/0179620 A1
(43) Pub. Date: Aug. 18, 2005

(54) Apparatus for driving plasma display panel

(75) Inventor: Tae Hyung Kim, Seoul (KR)

Correspondence Address: FLESHNER & KIM, LLP, P.O. BOX 221200, CHANTILLY, VA, 20153, US

(73) Assignee: LG Electronics Inc.

(21) Appl. No.: 11/055,084

(22) Filed: Feb. 11, 2005

(30) Foreign Application Priority Data
Feb. 17, 2004 (KR) 10-2004-0010504

(51) Int. Cl. G09G 3/28

(52) U.S. Cl. 345/60

(57) ABSTRACT

The present invention relates to a plasma display panel, and more particularly, to an apparatus for driving a plasma display panel, wherein driving margin can be secured according to characteristics of phosphors. A method of driving a plasma display panel including X electrodes to which data for light-emitting R, G and B phosphors are applied, a Y electrode to which a scan pulse and a sustain pulse are applied, and a Z electrode to which a sustain pulse is applied, wherein a control pulse is applied to the X electrodes corresponding to any one of the R, G and B phosphors in a sustain period where the sustain pulse is applied to the Y electrode and the Z electrode. According to the present invention, it is possible to secure driving margin without an additional circuit by applying a control pulse to each of the X electrodes corresponding to the R, G and B phosphors.

### BACKGROUND OF THE INVENTION

This Nonprovisional application claims priority under 35 U.S.C. § 119(a) on patent application No. 10-2004-0010504 filed in Korea on Feb. 17, 2004, the entire contents of which are hereby incorporated by reference.

### FIELD OF THE INVENTION

The present invention relates to a plasma display panel, and more particularly, to an apparatus for driving a plasma display panel, wherein driving margin can be secured according to characteristics of phosphors.

### BACKGROUND OF THE RELATED ART

FIG. 1 is a block diagram illustrating the construction of an apparatus for driving a plasma display panel in the prior art. As shown in FIG. 1, a signal processor 110 converts an externally inputted image signal into image data, which is suitable for the driving of the plasma display panel.

A data alignment unit 120 realigns data on a subfield basis in order to perform a gray scale process on the image data converted by the signal processor 110.

An X electrode driving unit 130 and a Y electrode driving unit 140 apply an address pulse and a scan pulse for forming a wall voltage in a discharge cell of the plasma display panel to X electrodes and Y electrodes, respectively. The Y electrode driving unit 140 and a Z electrode driving unit 150 alternately apply a sustain pulse for maintaining discharging of the discharge cell in which the wall voltage is formed to the Y electrodes and Z electrodes, respectively.

A main controller 160 controls the image data, which are realigned in the data alignment unit 120, to be sequentially read and then to be supplied to the X electrode driving unit 130 on one scan line basis, according to an external image signal, and applies a logic control pulse to a high voltage driving circuit 170.

The high voltage driving circuit 170 applies a high voltage control pulse to the X electrode, Y electrode and Z electrode driving units 130, 140 and 150 according to the logic control pulse from the main controller 160.

FIG. 2 shows a driving waveform for explaining a method of driving a plasma display panel in the prior art. As shown in FIG. 2, in a reset period, a scan period and an addressing period, corresponding pulses are applied to Y electrodes, Z electrodes and X electrodes to drive the plasma display panel.

At this time, data pulses are applied to R, G and B phosphors, respectively, through the X electrodes. As shown in FIG. 2, the pulses of the same waveform are applied to the R, G and B phosphors through the Y electrodes and the Z electrodes. Only when a cell to be discharged depending upon whether data exist is selected in the addressing period, the data pulses are separately applied through the X electrodes by the R, G and B phosphors.

Since a characteristic such as a discharge firing voltage of each of the R, G and B phosphors is different, driving margin of the plasma display panel is different by the R, G and B phosphors. That is, the R phosphor has the lowest discharge firing voltage, and the G phosphor has the highest discharge firing voltage.

Nevertheless, in the method of driving the plasma display panel according to the prior art, a reset pulse of the same waveform, a sustain pulse of the same waveform and an erase pulse of the same waveform are applied, and even the addressing voltage of the same Va voltage is applied to the R, G and B phosphors, respectively.

Accordingly, driving characteristics every R, G and B phosphors are different, and addressing margin, sustain margin, reset margin and the like reduce. For example, if a discharge firing voltage of the R phosphor is 220V to 240V, a discharge firing voltage of the B phosphor is 230V to 250V and a discharge firing voltage of the G phosphor is 235V to 255V, the discharge firing voltage that can be commonly applied to the three phosphors is 235V to 240V. Thus, margin is 5V. As such, if the pulse of the same waveform is applied to the phosphors having different discharge firing voltages, there occurs a problem that the margin of the discharge firing voltage, which can be commonly applied to the three phosphors, reduces.

In reality, in the reset period of FIG. 2, if the reset voltage is low when the ramp reset pulse is applied to the Y electrodes, there occurs a phenomenon that the reset operation of the G phosphor is short. Further, if the voltage of the ramp reset pulse is sufficiently high in line with the G phosphor, there is a problem that erroneous discharge occurs in the R phosphor.

### SUMMARY OF THE INVENTION

Accordingly, the present invention has been made in view of the above problems occurring in the prior art, and it is an object of the present invention to provide a method of driving a plasma display panel, wherein different pulses are applied according to R, G and B phosphors.

To achieve the above object, according to the present invention, there is provided a method of driving a plasma display panel including X electrodes to which data for light-emitting R, G and B phosphors are applied, a Y electrode to which a scan pulse and a sustain pulse are applied, and a Z electrode to which a sustain pulse is applied, wherein a control pulse is applied to the X electrodes corresponding to one or more of the R, G and B phosphors in a sustain period where the sustain pulse is applied to the Y electrode and the Z electrode. According to the present invention, the width of the control pulse is different according to characteristics of the R, G and B phosphors.

The present invention includes a combination of X electrodes to which a control pulse is applied and X electrodes grounded.

### BRIEF DESCRIPTION OF THE DRAWINGS

Further objects and advantages of the invention can be more fully understood from the following detailed description taken in conjunction with the accompanying drawings in which:

FIG. 1 is a block diagram illustrating construction of an apparatus for driving a plasma display panel in the prior art;

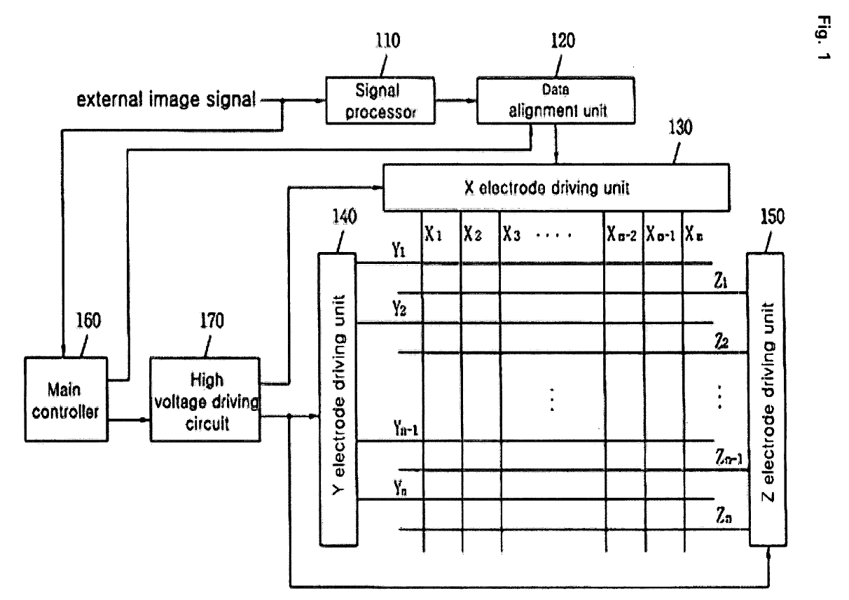

FIG. 2 shows a driving waveform for explaining a method of driving a plasma display panel in the prior art;

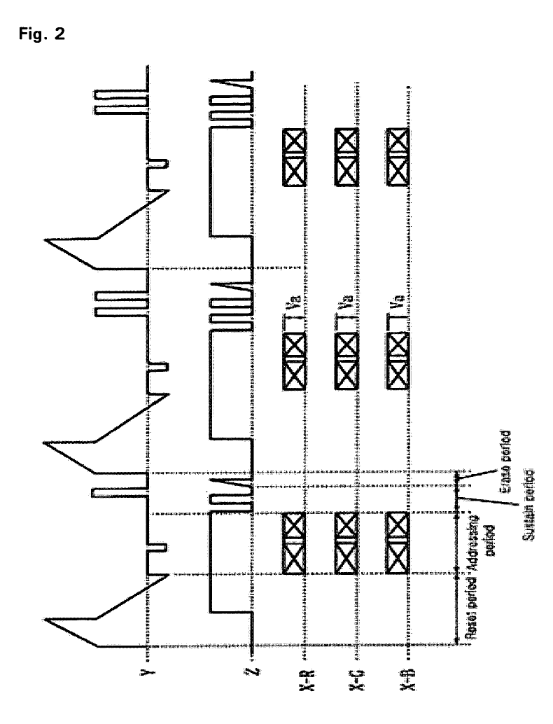

FIG. 3 shows a driving waveform for explaining a method of driving a plasma display panel according to the present invention; and

FIG. 4 is a block diagram illustrating construction of a common data IC.

### DETAILED DESCRIPTION OF THE PREFERRED EMBODIMENT

The present invention will now be described in detail in connection with preferred embodiments with reference to the accompanying drawings.

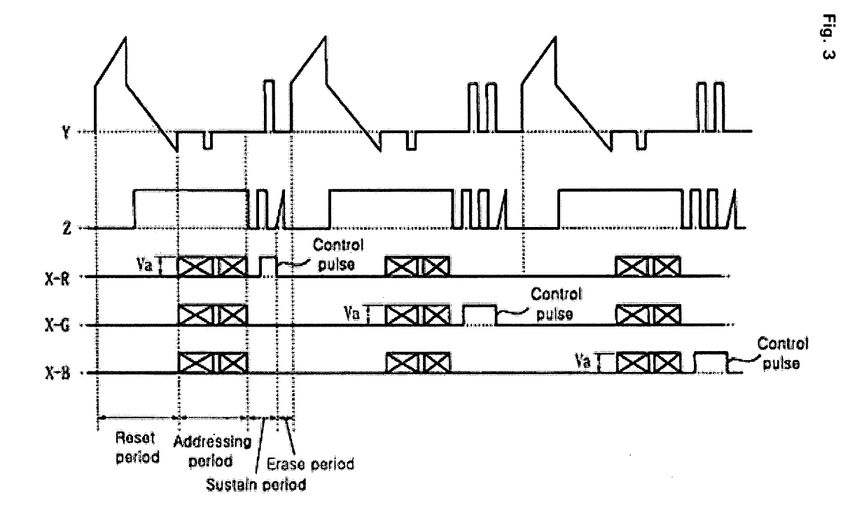

FIG. 3 shows a driving waveform for explaining a method of driving a plasma display panel according to the present invention.

According to the driving method in accordance with the present invention, as shown in FIG. 3, driving margin is secured by applying a control pulse in a sustain period with RGB phosphors having different pulse widths, and driving margin is secured through a combination of X electrodes to which control pulses are applied and X electrodes which are grounded.

That is, in order to secure driving margin, control pulses having a different width are biased to the X electrodes with a voltage Va during sustain period every RGB phosphors, thereby controlling wall charges of the X electrodes. Further, in order to control wall charges, the amount of the wall charges formed in the X electrodes is controlled by applying control pulses having voltage Va to the X electrodes or not applying it, i.e., grounding X electrodes.

For example, a stabilized reset operation is performed in the G phosphor region since a reset voltage is high. However, if erroneous discharge is generated in the R phosphor region, the control pulse is applied only to a X electrode corresponding to the R phosphor in the sustain period before the reset voltage is applied.

As such, if the control pulse is applied to only the X electrode corresponding to the R phosphor in the sustain period before the reset voltage is applied, the amount of wall charges formed in the X electrodes corresponding to the R phosphor is smaller than those formed in X electrodes corresponding to the B phosphor and the G phosphor. It is thus possible to prevent erroneous discharge from occurring in the R phosphor region in the reset period.

The driving method according to the present invention can be applied to various situations, which are generated due to not only the reset operation but also different characteristics of the R, G and B phosphors.

The method of driving the plasma display panel, which is implemented using a waveform as shown in FIG. 3, according to the present invention can be implemented through control of only a data IC included in the X electrode driving unit 130 without an additional circuit. The data IC receives data from the data alignment unit 120, and applies a data pulse corresponding to one sub-field to X electrodes.

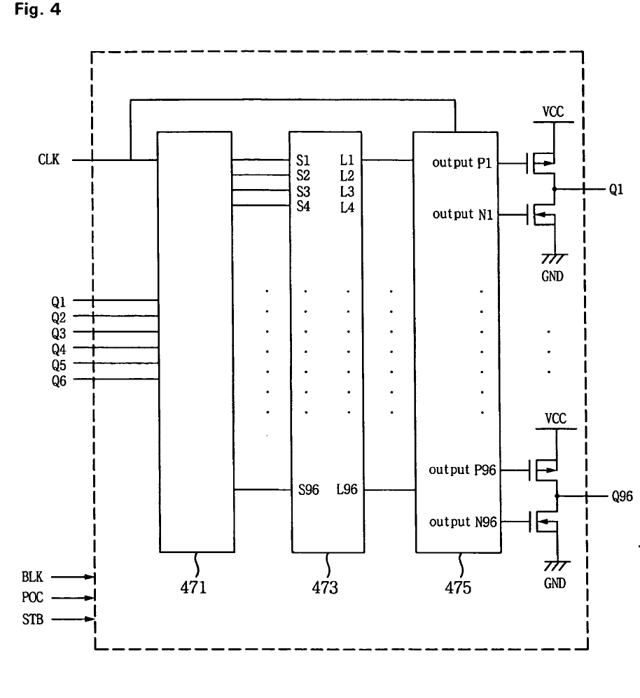

FIG. 4 is a block diagram illustrating construction of a common one data IC. The method of driving the plasma display panel according to the present invention can be implemented without an additional circuit by using a common data IC.

Referring to FIG. 4, the common data IC includes a shift register 471, a latch 473 and an output logic unit 475. In the conventional data IC, data received through 4 input pins are stored in the shift register 471 during 16 clocks, and are then output to the latch 473. The latch 473 allows the data to be applied to the X electrodes through 96 output pins in a scan process.

The operation of this general data IC is controlled by control signals BLK, POC and STB received from the data alignment unit 120. The following table shows a true table for the operation of the common data IC.

| Qn | STB | BLK | POC | Output | Note |
|---|---|---|---|---|---|
| X | X | L | X | All L | Output LOW level |
| X | X | H | L | All H | Output HIGH level |
| X | H | H | H | Qn | Latch data |
| L | L | H | H | L | Sustain data |
| H | L | H | H | H | Sustain data |

At this time, in the above table, On indicates data received from the data alignment unit, “L” indicates a LOW level, “H” indicates a HIGH level, and “X” indicates that both L and H are possible.

As can be seen from the above table, if both the BLK and POC signals are at a HIGH level and the STB signal is at a LOW level, the output of the data IC keeps intact. This means that if the STB signal is changed to a HIGH level and the output of the data IC is not changed to new input data, the data IC keeps outputting the last data.

It is assumed that the plasma display panel performs an addressing operation for 480 lines. In this case, in the driving method according to the present invention, when the data IC performs 481^{th} addressing, the data IC receives the STB signal of a HIGH level, the BLK signal of a HIGH level and the POC control signal of a HIGH level from the data alignment unit 120, and applies a control pulse to a X electrode corresponding to one of the R, G and B phosphors. Thereafter, if the data IC receives the STB signal of a LOW signal, the BLK signal of a HIGH level and the POC control signal of a HIGH level, the value by the control pulse keeps intact until the STB control signal becomes a HIGH level.

For example, when the data IC performs 481^{th} addressing, if the data IC applies the control pulse only to the X electrode corresponding to the R phosphor, a logic value of the X electrodes corresponding to the G phosphor becomes 0, a logic value of the X electrode corresponding to the B phosphors becomes 0, and a logic value of the X electrode corresponding to the R phosphor becomes 1. The corresponding logic values are kept until the STB control signal becomes a HIGH level. Thus, the control pulse serves to bias Va to the X electrode corresponding to the R phosphor in the sustain period.

As described above, if the 6 pin input is used, the shift register 471 sends 96 data to the latch 473 during the 16 clocks. The latch 473 temporarily stores the data, and then transmits the data to the output logic unit 475. The output logic unit 475 drives the X electrodes according to the data.

The data electrode driving unit according to the present invention applies an additional control pulse corresponding to the data electrode driving voltage Va to the X electrode corresponding to one of R, G and B phosphors in the sustain period. The data electrode driving unit controls the width of the control pulse according to characteristics of the phosphors.

The width of the control pulse can be controlled by applying the BLK signal as the voltage Va and then selecting a time point where the BLK signal is changed to the ground state, as described above. That is, if the time point where the BLK signal is changed to the ground state after the voltage Va is applied is long, the pulse width becomes lengthy, and vice verse.

As described above, according to the present invention, in order to secure driving margin, a common data IC is controlled to apply a control pulse to a X electrode corresponding to each of phosphors in a sustain period.

Through this method, it is possible to apply a bias voltage to X electrodes corresponding to each of the R, G and B phosphors in the sustain period of FIG. 3.

As described above, according to the present invention, a control pulse is applied to each of X electrodes corresponding to R, G and B phosphors. Therefore, the present invention is advantageous in that it can secure driving margin without an additional circuit.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

1. A plasma display apparatus including a data electrode driving unit for applying data for light-emitting R, G and B phosphors to data electrodes, a scan electrode driving unit for applying a scan pulse and a sustain pulse to a scan electrode, and a sustain electrode driving unit for applying a sustain pulse to a sustain electrode,
wherein the data electrode driving unit applies a control pulse to the data electrode corresponding to one of the R, G and B phosphors in a sustain period where the sustain pulse is applied to the scan electrode and the sustain electrode.

2. The plasma display apparatus as claimed in claim 1, wherein the data electrode driving unit controls the widths of the control pulses differently according to characteristics of the R, G and B phosphors.

3. The plasma display apparatus as claimed in claim 1, wherein the data electrode driving unit controls the amount of wall charges by applying the control pulse to the data electrode or grounding the data electrode

4. The plasma display apparatus as claimed in claim 2, wherein the data electrode driving unit controls the width of the control pulse by selecting a time point where application of the control pulse is finished.

5. A method of driving a plasma display apparatus including a data electrode driving unit for applying data for light-emitting R, G and B phosphors to data electrodes, a scan electrode driving unit for applying a scan pulse and a sustain pulse to a scan electrode, and a sustain electrode driving unit for applying a sustain pulse to a sustain electrode,
wherein the data electrode driving unit applies a control pulse to data electrode corresponding to one of the R, G and B phosphors in a sustain period where the sustain pulse is applied to the scan electrode and the sustain electrode.

6. The method as claimed in claim 5, wherein the data electrode driving unit controls the widths of the control pulses differently according to characteristics of the R, G and B phosphors.

7. The method as claimed in claim 5, wherein the data electrode driving unit controls the amount of wall charges by applying the control pulse to the data electrode or grounding the data electrode.

8. The method as claimed in claim 6, wherein the data electrode driving unit controls the width of the control pulse by selecting a time point where application of the control pulse is finished.
